(19) United States
(12) Patent Application Publication
(10) Pub. No.: US 2010/0090653 A1
(43) Pub. Date: Apr. 15, 2010

(54) BATTERY DEVICE

(75) Inventors: Yuuki KUWANO, Tokyo (JP); Ryuichi Morikawa, Tokyo (JP); Mami Mizutani, Tokyo (JP); Yukitaka Monden, Tokyo (JP); Masayuki Kubota, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/576,499

(22) Filed: Oct. 9, 2009

(30) Foreign Application Priority Data
Oct. 10, 2008 (JP) P2008-264042

(51) Int. Cl. H02J 7/00

(52) U.S. Cl. 320/136

(57) ABSTRACT

A battery device includes electric cells connected in series, resistors connected to respective electrodes of the electric cells, discharge switches for discharging voltages between the respective electrodes of each of the battery cells via the resistors, and a voltage detection and control circuit. When a detection voltage when the discharge switch is closed and not disconnected is defined as V, a detection voltage when a discharge switch is closed and disconnected is defined as V_{S}, and a detection voltage when a discharge switch is not closed and not disconnected is defined as V_{E}, the voltage detection and control circuit arranges a relationship between a disconnect determination voltage V_{SL} and a discharge malfunction determination voltage V_{SH} so as to be V_{E}>V_{SH}>V>V_{SL}>V. The battery device includes a method of making a malfunction detection signal for determining the battery device as a malfunction when at least one of voltages of the electric cells detected when closing the discharge switch is determined to be the discharge malfunction determination voltage V_{SH} or more, or the disconnect determination voltage V_{SL} or less.

### BACKGROUND OF THE INVENTION

1. Field of the Invention

The present invention relates to a battery device including unit cells (hereinafter referred to as electric cells) connected in series. Specifically, the present invention relates to a battery device capable of detecting a disconnection of voltage detection lines provided in each of the electric cells, a cell balance nonconformity, disconnection points of the voltage detection lines, and an over-charge and over-discharge in each of the electric cells.

2. Description of the Related Art

A conventional battery device includes electric cells connected in series, and a voltage measuring function and a cell balance function in each of the electric cells. The voltage measuring function is a function to measure a voltage between terminals in each of the electric cells, and determine that the battery device is “conformity” if the measured voltage values are within a predetermined voltage range. Also, the cell balance function is a function to determine charging and discharging conditions of all of the electric cells by use of a cell balance circuit configured to measure a charged voltage and a discharged voltage of each of the electric cells (Japanese Patent Laid-Open Publication No. 2007-085847).

### SUMMARY OF THE INVENTION

However, the above-mentioned conventional battery device merely includes the voltage measuring function and the cell balance function, and merely is carried out to determine a criterion of a nonconformity of a voltage between terminals in each of the electric cells or charging and discharging conditions of all of the battery cells. Such a battery device did not have a method for specifying nonconformity causes, such as determining disconnection points of the voltage detection lines and detecting an over-charge and over-discharge in each of the electric cells. Thus, quality enhancements in such a battery device could not be achieved.

The present invention has been made in consideration for the above-mentioned problem. It is an object of the present invention to provide a battery device including electric cells connected in series, the battery device being capable of detecting a disconnection of voltage detection lines provided in each of the electric cells, a cell balance nonconformity, and an over-charge and over-discharge in each of the electric cells so as to determine the battery device itself as a malfunction when at least one electric cell is determined as a malfunction as a result of the detection.

To achieve the above-described object, a first aspect of the present invention provides a battery device comprising: electric cells connected in series; resistors connected to respective electrodes of the electric cells; discharge circuits for discharging voltages between the respective electrodes of the electric cells via the resistors; and a detection and control circuit for detecting the voltages between the respective electrodes of the electric cells via the resistors, and performing discharge control by closing a set discharge circuit of the discharge circuits. When a detection voltage obtained when the set discharge circuit is closed and a corresponding electric cell is in a normal condition is defined as V, a detection voltage obtained when the set discharge circuit is closed and the set discharge circuit is in a disconnect state is defined as V_{S}, a detection voltage obtained when the set discharge circuit is not closed and the set discharge circuit is not in a disconnect state is defined as V_{E}, a disconnect determination voltage arranged between the detection voltage V in the normal condition and the detection voltage V_{S} in the disconnect state, and defined as a criterion voltage to determine the set discharge circuit to be in a disconnect state with respect to a voltage detected when the set discharge circuit is closed is defined as V_{SL}, and a discharge malfunction determination voltage arranged between the detection voltage V in the normal condition and the detection voltage V_{E} with the certain discharge circuit not closed, and defined as a criterion voltage to determine the set discharge circuit not to be in a disconnect state with respect to a voltage detected when the set discharge circuit is not closed is defined as V_{SH}, the detection and control circuit arranges a relationship between the voltages V_{SL} and V_{SH} so as to be

V_{E}>V_{SH}>V>V_{SL}>V_{S}

with respect to the respective voltages V, V_{S} and V_{E}. A corresponding electric cell is determined as a malfunction when at least one of the voltages detected in the detection and control circuit with the discharge circuits closed is determined to be the discharge malfunction determination voltage V_{SH}or more, or the disconnect determination voltage V_{SL} or less.

According to the battery device of the first aspect of the present invention, it is possible to provide the battery device capable of determining the battery device itself as a malfunction when at least one of the voltages between the respective electrodes in all of the electric cells is determined to be the discharge malfunction determination voltage V_{SH} or more, or the disconnection determination voltage V_{SL} or less. Thus, the quality of the battery device is maintained, thereby obtaining high reliability.

In addition, to achieve the above-described object, a second aspect of the present invention provides a method of making a malfunction detection signal for the battery device according to claim 1, the method comprising: a first step of determining whether voltages between the both electrodes of the respective electric cells when not closing the discharge circuits meet a predetermined voltage so as to determine a criterion whether all of the electric cells are conformity; a second step of detecting and recording voltages of all of the electric cells with the discharge circuits closed when the voltages between the respective electrodes of all of the electric cells are conformity as a result of a determination in the first step; a third step of determining whether at least one of the voltages detected in the second step is the discharge malfunction determination voltage V_{SH} or more; a fourth step of determining a corresponding electric cell to be in a discharge circuit malfunction state when at least one of the voltages is determined to be the discharge malfunction determination voltage V_{SH} or more as a result of a determination in the third step; a fifth step of determining whether at least one voltage is the disconnect determination voltage V_{SL} or less when all of the voltages are determined to be less than the discharge malfunction determination voltage V_{SH} as a result of the determination in the third step; and a sixth step of determining a corresponding discharge circuit to be in a disconnect state when at least one of the voltages detected in the second step is determined to be the disconnect determination voltage V_{SL}, or less as a result of a determination in the fifth step. A corresponding electric cell is determined as a malfunction when the at least one of the voltages detected in the second step is determined to be the discharge malfunction determination voltage V_{SH} or more, or the disconnect determination voltage V_{SL} or less.

According to the method of making the malfunction detection signal of the second aspect of the present invention, it is possible to provide the method of detecting a corresponding electric cell as a malfunction, and at the same time, the battery device itself as a malfunction when at least one of the voltages detected when closing the discharge circuits is determined to be the discharge malfunction determination voltage V_{SH} or more, or the disconnection determination voltage V_{SL} or less. Thus, the quality of the battery device is maintained, thereby obtaining high reliability.

According to the aspects of the present invention, it is possible to provide the battery device including the electric cells connected in series, the battery device detecting a disconnection of voltage detection lines provided in each of the electric cells, a cell balance nonconformity, and an over-charge and over-discharge in each electric cell. As a result, it is possible to provide the battery device for determining the battery device itself as a malfunction when at least one electric cell is determined as a malfunction.

### BRIEF DESCRIPTION OF THE DRAWINGS

FIG. 1 is a block diagram of a battery device according to an embodiment of the present invention.

FIG. 2 is a flow chart showing a method of making a malfunction detection signal according to an embodiment of the present invention.

### DETAILED DESCRIPTION OF THE EMBODIMENTS

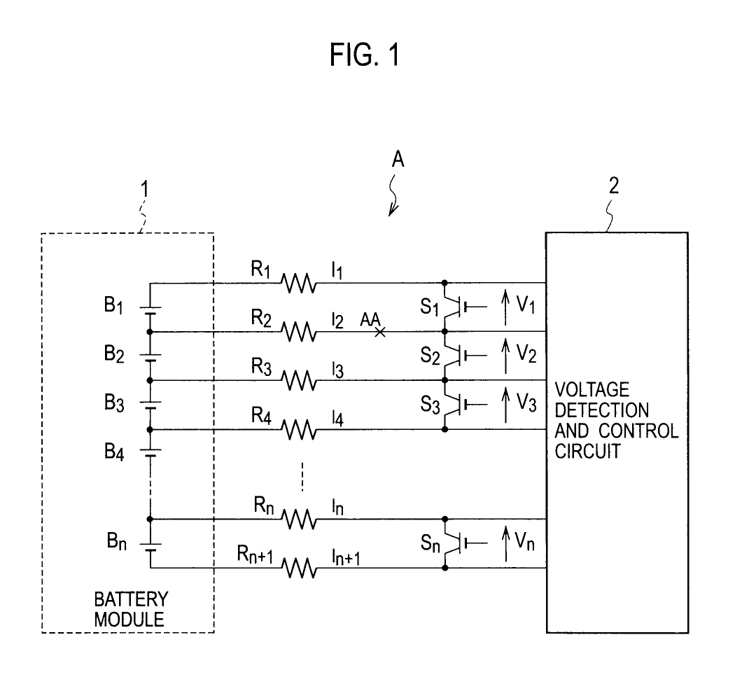

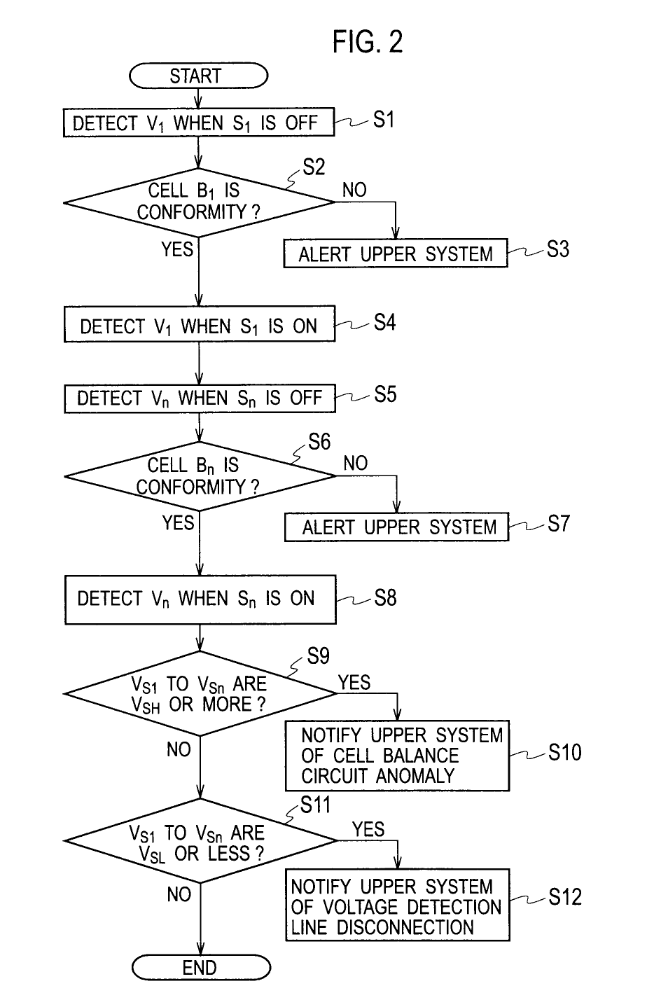

Hereinafter, description will be made below in detail of an embodiment of the present invention with reference to FIGS. 1 and 2.

A battery device according to the embodiment of the present invention determines the battery device as a defective due to a battery device malfunction when any disconnection of voltage detection lines or cell balance nonconformity is detected in at least one of electric cells composing the battery device, as described later. Even if such a malfunction is not detected, the battery device treats the battery device as a defective due to a malfunction of the battery device when an over-charge or over-discharge is detected in at least one electric cell. Thus, the battery device double-checks all of the electric cells so as to strengthen quality control of the battery device. Accordingly, it is possible to maintain high performance of the battery device for a long period. In addition, it is possible to provide the battery device while achieving high reliability by users.

A battery device A according to the embodiment of the present invention, as shown in FIG. 1, includes electric cells B₁, B₂, B₃, B₄, . . . , Bₙ connected in series, resistors R₁, R₂, R₃, . . . , Rₙ, Rₙ₊₁ of which each one end is connected to respective terminals of the electric cells B₁, B₂, B₃, B₄, . . . , Bₙ, voltage detection lines l₁, l₂, l₃, l₄, . . . , lₙ, lₙ₊₁ connected to another end of the respective resistors, a voltage detection and control circuit 2 connected to respective voltage detection lines, and discharge switches S₁, S₂, S₃, . . . , Sₙ connected between the respective adjacent two voltage detection lines l₁-l₂, l₂-l₃, l₃-l₄, . . . , lₙ-lₙ₊₁.

For convenience, a battery module 1 including the electric cells B₁, B₂, . . . , Bₙ connected in series, the resistors R₁, R₂, . . . , Rₙ, the voltage detection lines l₁, l₂, . . . , lₙ, lₙ₊₁, the voltage detection and control circuit 2, and the discharge switches S₁, S₂, . . . , Sₙ are integrally providing.

The discharge switches S₁, S₂, . . . , Sₙ are electronic switches, for instance. Switching control terminals for a closing and opening control (hereinafter referred to as an “on-off control”) of the discharge switches S₁, S₂, . . . , Sₙare supplied with switching control signals from the voltage detection and control circuit 2 according to a flow chart (FIG. 2) as described later, thereby performing the on-off control.

Then, the resistor R₁, the voltage detection line l₁, the discharge switch S₁, the voltage detection line l₂ and the resistor R₂ constitute a cell balance circuit (discharge circuit) of the electric cell B₁. Also, the resistor R₂, the voltage detection line l₂, the discharge switch S₂, the voltage detection line l₃ and the resistor R₃ constitute a cell balance circuit of the electric cell B₂. Such a cell balance circuit is provided in the respective electric cells B₁, B₂, . . . , Bₙ. Each cell balance circuit discharges a voltage between both electrodes of the respective electric cells B₁, B₂, . . . , Bₙ via the resistors R₁, R₂, . . . , Rₙ Rₙ₊₁.

The voltage detection and control circuit 2 detects voltages between both electrodes (terminals) of the arbitrary number of the electric cells B₁, B₂, . . . , Bₙ via the resistors R₁, R₂, . . . , Rₙ, Rₙ₊₁. Also, the voltage detection and control circuit 2 performs various processing controls for the electric cells B₁, B₂, . . . , Bₙ according to the flow chart (FIG. 2) as described later. In this case, it is acceptable to detect odd-numbered electric cells such as the electric cells B₁, B₃, . . . first, followed by detecting even-numbered electric cells such as the electric cells B₂, B₄, . . . and so on.

The following are descriptions of a “disconnect detection of the voltage detection lines” when the voltage detection line l₂ is disconnected at an AA point in FIG. 1, for instance. Also, the following are descriptions of a “malfunction detection of the cell balance circuits” when a malfunction is detected in the discharge switch S₂ in the cell balance circuit of the electric cell B₂, for instance.

When the voltage detection line l₂ is not disconnected and no malfunction is detected in the discharge switch S₂ in the cell balance circuit of the electric cell B₂, a voltage V₂ detected at the voltage detection and control circuit 2 when turning the discharge switch S₂ on and activating a cell balance function can be obtained by the following formula (1) (Note that, the other switches except the discharge switch S₂ are off).

V₂=B ₂×R_{S}/(2R+R_{S}) (1)

Note that, R is a resistance of the resistors R₁, R₂, . . . , Rₙ, Rₙ₊₁, and R_{S} is an on-resistance that the discharge switch has when the discharge switch is on.

### (Disconnect Detection of Voltage Detection Lines)

When the voltage detection line l₂ is disconnected, a voltage V_{2S} detected at the voltage detection and control circuit 2 when turning the discharge switch S₂ on and activating the cell balance function can be obtained by the following formula (2).

V_{2S}=(B₁+B₂)×R_{S}/(2R+R_{S}+R_{1IN}) (2)

Note that, R_{1IN} is an input impedance between input terminals to which the discharge switch S₁ of the voltage detection and control circuit 2 is connected, and V_{2S} is a voltage value applied between input terminals of the voltage detection and control circuit 2 to which the discharge switch S₂ is connected when the discharge switch S₂ is on. In this case, the input impedance of the voltage detection and control circuit 2 is substantially high, i.e. R_{1IN}>>2R+R_{S}. Thus, it results in V₂>>V_{2S}.

According to this relationship, a disconnect determination voltage V_{SL} is arranged between the voltage V₂ and the voltage V_{2S}. Then, by detecting the voltage when turning the discharge switch S₂ on and activating the cell balance function, and by determining whether the detected voltage value exceeds the disconnect determination voltage V_{SL} or not, the disconnection of the voltage detection line l₂ can be determined.

### (Malfunction Detection of Cell Balance Circuits)

When the voltage detection line l₂ is not disconnected and no malfunction is detected in the discharge switch S₂, the voltage V₂ when turning the discharge switch S₂ on and activating the cell balance function can be obtained by the above-mentioned formula (1). In this case, the discharge switch S₁ is off.

While, when a malfunction is detected, e.g. when the discharge switch S₂ in the cell balance circuit is not turned on properly, a voltage V_{2E} detected at the voltage detection and control circuit 2 can be obtained by the following formula (3).

V_{2E}=B₂×R_{SE}/(2R+R_{SE}) (3)

Note that, R_{SE} is an on-resistance that the discharge switch has when the cell balance circuit is detected as a malfunction, e.g. when the discharge switch S₂ is not turned on properly. In this case, R_{SE}>>R_{S}, thus, it results in V_{2E}>V₂. When R_{SE} is substantially high, the voltage V_{2E} is approximately the same voltage detected at the voltage detection and control circuit 2 when the discharge switch S₂ is off.

According to this relationship, a discharge malfunction determination voltage V_{SH} is arranged between the voltage V₂ and the voltage V_{2E}. Then, by detecting the voltage when turning the discharge switch S₂ on and activating the cell balance function, and by determining whether the detected voltage value exceeds the discharge malfunction determination voltage V_{SH} or not, the malfunction of the cell balance circuit can be detected.

Namely, the relationship between the discharge malfunction determination voltage V_{SH} and the disconnect determination voltage V_{SL}, is arranged so as to be,

V_{2E}>V_{SH}>V₂>V_{SL}>V_{2S},

with respect to the respective obtained voltages V₂, V_{2S} and V_{2E}.

The discharge malfunction determination voltage V_{SH} and the disconnect determination voltage V_{SL} can be obtained by the following formulae (4) and (5), for instance.

V_{SH}=2×(cell over-charge voltage value)×R_{S}/(2R+R_{S}) (4)

V_{SL}=½×(cell over-discharge voltage value)×R_{S}/(2R+R_{S}) (5)

Then, by performing calculations using the formulae (4) and (5) with respect to each of the discharge switches S₁, S₂, . . . , Sₙ, it is possible to detect the disconnection of the respective voltage detection lines l₁, l₂, . . . , lₙ, lₙ₊₁, and detect the malfunction of the respective cell balance circuits.

Next, the following are descriptions of the detection of the voltage detection line disconnection and the cell balance circuit nonconformity, and the detection of the over-charge and over-discharge as an embodiment of the method of making a malfunction detection signal of the present invention by use of the flow chart in FIG. 2.

Before the process of the flow chart of the present embodiment, all the electric cells B₁, B₂, . . . , Bₙ are assumed to be fully charged in advance.

First, the voltage V₁ between the terminals of the first discharge switch S₁ is detected when the discharge switch S₁ of the discharge switches S₁, S₂, . . . , Sₙ arranged in series is off (“Detect V₁ when S₁ is off”: Step S1).

Next, it is determined a criterion whether the detected voltage V₁ between the terminals is equivalent to the charged voltage of the electric cell B₁ (“Cell B₁ is conformity?”: Step S2). When the both values are not equivalent (NO), the electric cell B₁ is determined as a “malfunction”, and an “alert” of the “malfunction” is sent to an upper system (“Alert upper system”: Step S3). Note that, the upper system is a system to control an entire hybrid vehicle including the battery device A, for instance, and to be placed in a rank higher than a battery device control level. The upper system determines the battery device A as a “defective” due to the “alert”. While, when the both voltage values are equivalent (YES), the electric cell B₁ is determined as a “conformity”, followed by Step S4.

Then, the discharge switch S₁ is turned on so as to detect the voltage V₁ between the terminals of the discharge switch S₁. The detected voltage is stacked (overwritten) as a stack voltage V_{S1} in a memory not shown in the figure (“Detect V₁ when S₁ is on”: Step S4).

Thus, a series of steps for the discharge switch S₁ (Step S1 to Step S4) is finished. Then, a series of steps for the discharge switch S₃ is immediately started. The series of steps for the discharge switch S₃ is similar to the series of steps for the discharge switch S₁. Similarly, the respective series of steps for the odd-numbered discharge switches S₅, S₇, . . . are performed in order.

Then, similar to the series of steps for the odd-numbered discharge switches, the respective series of steps for the even-numbered discharge switches S₂, S₄, S₆, S₈. . . (similar to Step S1 to Step S4) are performed in order.

Thus, the all series of steps for the discharge switches S₁, S₂, S₃, . . . Sₙ₋₁ except the last discharge switch Sₙ is finished.

As a result, when all the electric cells B₁, B₂, B₃, B₄, . . . , Bₙ₋₁ are determined as a “conformity”, the stack voltages V_{S2}, V_{S3}, . . . , V_{Sn-1} are equivalent to the voltages V₂, V₃, . . . , Vₙ₋₁ between the terminals of the discharge switches S₂, S₃, . . . , Sₙ₋₁ when the respective discharge switches S₂, S₃, . . . , Sₙ₋₁ are off.

Then, the voltage Vₙ between the terminals of the discharge switch Sₙ is detected when the last discharge switch Sₙ is off (“Detect Vₙ when Sₙ is off”: Step S5).

Next, it is determined a criterion whether the detected voltage Vₙ between the terminals is equivalent to the fully charged voltage of the electric cell Bₙ (“Cell Bₙ is conformity?” : Step S6). When the both values are not equivalent (NO), the electric cell Bₙ is determined as a “malfunction”, and an “alert” of the “malfunction” is sent to the upper system (“Alert upper system”: Step S7). The upper system determines the battery device A as a “defective” due to the “alert”. While, when the both voltage values are equivalent (YES), the electric cell Bₙ is determined as a “conformity”, followed by Step S8.

Then, the discharge switch Sₙ is turned on so as to detect the voltage Vₙ between the terminals of the discharge switch Sₙ. The detected voltage is stacked as a stack voltage V_{Sn} in a memory not shown in the figure (Detect Vₙ when Sₙ is on”: Step S8).

As a result, the following steps are performed only when all the electric cells B₁, B₂, B₃, B₄, . . . , Bₙ, are determined as a “conformity”.

Next, it is determined criteria whether all the stack voltages V_{S1}, V_{S2}, . . . , V_{Sn} are the predetermined discharge malfunction determination voltage V_{SH} or more (“V_{S1} to V_{Sn} are V_{SH} or more?”: Step S9). The predetermined discharge malfunction determination voltage V_{SH} is configured to be larger than the fully charged voltage V₁ with a predetermined value. As a result of the determination of the criteria, when any of the stack voltages V_{S1}, V_{S2}, . . . , V_{Sn} are the predetermined discharge malfunction determination voltage V_{SH} or more, the corresponding electric cells are determined to be in an over-charge state (YES), and the upper system is notified of a “cell balance circuit nonconformity” (“Notify upper system of cell balance circuit nonconformity”: Step S10). While, when all the stack voltages V_{S1}, V_{S2}, . . . , V_{Sn} are less than the predetermined discharge malfunction determination voltage V_{SH} (NO), the next Step S11 is performed.

Then, it is determined a criterion whether all the stack voltages V_{S1}, V_{S2}, . . . , V_{Sn} are the predetermined disconnect determination voltage V_{SL} or less (“V_{S1} to V_{Sn} are V_{SL} or less?”: Step S11). The disconnect determination voltage V_{SL} is configured to be smaller than the discharge voltage of the battery device A with a predetermined value. As a result of the determination of the criterion, when any of the stack voltages V_{S1}, V_{S2}, . . . , V_{Sn} are the predetermined disconnect determination voltage V_{SL}, or less, the corresponding electric cells are determined to be in an over-discharge state (YES), and the upper system is notified of a voltage detection line disconnection (“Notify upper system of voltage detection line disconnection”: Step S12). While, when all the stack voltages V_{S1}, V_{S2}, V_{S3}, . . . , V_{Sn} are more than the predetermined disconnect determination voltage V_{SL} (NO), the above-described series of steps according to the present embodiment is completed.

As described above, according to the method of making the malfunction detection signal of the embodiment of the present invention, when any voltage detection line disconnection and cell balance nonconformity is detected in at least one of the electric cells, the battery device itself is determined as a defective due to a battery device malfunction. Even if such a malfunction is not detected, the battery device is determined as a defective due to a battery device malfunction when at least one electric cell is determined to be in an over-charge or over-discharge state. Thus, due to the method of making the malfunction detection signal according to the present invention, it is possible to double-check all the electric cells so as to strengthen quality control of the battery device. Accordingly, it is possible to maintain high performance of the battery device for a long period. In addition, it is possible to provide the battery device while achieving high reliability by users.

What is claimed is:

1. A battery device comprising:
electric cells electrically-connected in series;
resistors connected to respective electrodes of the electric cells;
discharge circuits for discharging voltages between the respective electrodes of the electric cells via the resistors; and
a detection and control circuit for detecting the voltages between the respective electrodes of the electric cells via the resistors, and performing discharge control by closing a set discharge circuit of the discharge circuits, wherein
a detection voltage obtained when the set discharge circuit is closed and a corresponding electric cell is in a normal condition is defined as V,
a detection voltage obtained when the set discharge circuit is closed and the set discharge circuit is in a disconnect state is defined as V_{S},
a detection voltage obtained when the set discharge circuit is not closed and the set discharge circuit is not in a disconnect state is defined as V_{E},
a disconnect determination voltage arranged between the detection voltage V in the normal condition and the detection voltage V_{S} in the disconnect state, and defined as a criterion voltage to determine the set discharge circuit to be in a disconnect state with respect to a voltage detected when the set discharge circuit is closed is defined as V_{SL},
a discharge malfunction determination voltage arranged between the detection voltage V in the normal condition and the detection voltage V_{E} with the certain discharge circuit not closed, and defined as a criterion voltage to determine the set discharge circuit not to be in a disconnect state with respect to a voltage detected when the set discharge circuit is not closed is defined as V_{SH},
the detection and control circuit arranges a relationship between the voltages V_{SL} and V_{SH} so as to be
V_{E}>V_{SH}>V>V_{SL}>V_{S}
with respect to the respective voltages V, V_{S} and V_{E}, and
a corresponding electric cell is determined as a malfunction when at least one of the voltages detected in the detection and control circuit with the discharge circuits closed is determined to be the discharge malfunction determination voltage V_{SH} or more, or the disconnect determination voltage V_{SL} or less.

2. A method of making a malfunction detection signal detecting a malfunction of the battery device according to claim 1, the method comprising:
a first step of determining whether voltages between the both electrodes of the respective electric cells when not closing the discharge circuits meet a predetermined voltage so as to determine a criterion whether all of the electric cells are conformity;
a second step of detecting and recording voltages of all of the electric cells with the discharge circuits closed when the voltages between the respective electrodes of all of the electric cells are conformity as a result of a determination in the first step;
a third step of determining whether at least one of the voltages detected in the second step is the discharge malfunction determination voltage V_{SH} or more;
a fourth step of determining a corresponding electric cell to be in a discharge circuit malfunction state when at least one of the voltages is determined to be the discharge malfunction determination voltage V_{SH} or more as a result of a determination in the third step;
a fifth step of determining whether at least one voltage is the disconnect determination voltage V_{SL} or less when all of the voltages are determined to be less than the discharge malfunction determination voltage V_{SH} as a result of the determination in the third step; and
a sixth step of determining a corresponding discharge circuit to be in a disconnect state when at least one of the voltages detected in the second step is determined to be the disconnect determination voltage V_{SL} or less as a result of a determination in the fifth step, wherein
a corresponding electric cell is determined as a malfunction when the at least one of the voltages detected in the second step is determined to be the discharge malfunction determination voltage V_{SH} or more, or the disconnect determination voltage V_{SL} or less.
